(19) United States
(12) Patent Application Publication
(10) Pub. No.: US 2020/0145545 A1
(43) Pub. Date: May 7, 2020

(54) INPUT DEVICE AND IMAGE FORMING DEVICE

(71) Applicant: KONICA MINOLTA, INC., Tokyo (JP)

(72) Inventor: Hisataka FUNAKAWA, Tokyo (JP)

(73) Assignee: KONICA MINOLTA, INC., Tokyo (JP)

(21) Appl. No.: 16/667,878

(22) Filed: Oct. 29, 2019

(30) Foreign Application Priority Data
Nov. 2, 2018 (JP) 2018-207664

(51) Int. Cl. H04N 1/00; G06F 3/01; G06F 3/0488

(52) U.S. Cl. CPC H04N 1/00549; H04N 1/00411; G06F 3/04883; G06F 3/016

(57) ABSTRACT

An input device and image forming device which can present the user a response by vibration uniformly regardless of the position where the user touches on an operation panel. The input device includes: a vibrating element which vibrates an operation panel unit in at least one direction; a vibration absorbing member which connects the operation panel unit with the device main body and absorbs the vibration of the operation panel unit; and a vibration controller which enables the vibrating element to give a vibration according to the condition in which an operation input is received on the operation panel unit. The vibration controller corrects the amount of vibration in driving the vibrating element by the amount of correction set according to the position where the vibrating element is mounted on the operation panel unit.

### CROSS-REFERENCE TO RELATED APPLICATIONS

The entire disclosure of Japanese Patent Application No. 2018-207664, filed on Nov. 2, 2018, is incorporated herein by reference in its entirety.

### BACKGROUND

### Technological Field

The present invention relates to an input device and an image forming device and more particularly to a technique which vibrates part of an operation unit of a device.

### Description of the Related Art

In the past, in mobile terminals such as smartphones, various techniques to give a vibration as a response to operation of a touch panel or the like have been put into practical use. Specifically, a vibrating element called a vibrator is built in a mobile terminal and as a response to a touch on the touch panel, the vibrating element vibrates the mobile terminal for a preset time period to respond to the user holding the mobile terminal by vibration.

In the case of a mobile terminal such as a smartphone, the user operates the mobile terminal while holding it, so the vibration given by the vibrating element is directly transmitted to the hand of the user. Therefore, the area which is vibrated by the vibrating element is not related to the pressed position on the touch panel and the vibration should be uniformly transmitted to the hand holding the mobile terminal. Generally, the back side of the terminal is vibrated strongly.

Japanese Patent No. 5658493 (Patent Literature 1) describes a technique for a tactile presentation device with a touch panel which presents the user several steps of tactile sensation by changing the tactile sensation according to the position where the user touches on the panel.

### CITATION LIST

### Patent Literature

Patent Literature 1: Japanese Patent No. 5658493

### SUMMARY

In the recent years, even in the field of stationary digital multifunctional machines, models with a touch panel have been becoming popular. In such stationary machines too, the technique to use a vibrating member to give the user a response when the user touches the touch panel has been proposed. However, the stationary digital multifunctional machines are different in the manner of transmission of vibration from the mobile terminals which transmit the vibration to the hand holding the terminal: in the stationary machines, only the finger that has touched the touch panel is vibrated, so it is difficult to make a response with a uniform intensity of vibration.

Specifically, when the touch panel itself is vibrated to make a response to the user who has touched the panel, if the vibration is not uniformly transmitted to the finger which has touched the panel, in some situations the vibration may be hardly transmitted to the finger. However, one problem is that it is very difficult to give a vibration uniformly regardless of the touched position, or whether the center area or peripheral area of the touch panel is touched.

Another problem is that in a stationary digital multifunctional machine, various components are arranged densely in the machine and in some cases a vibrating element cannot be installed in an optimum position to vibrate the touch panel. In such cases, the touch panel would be vibrated more ununiformly.

As described in Patent Literature 1, the technique which positively changes the tactile sensation generated by vibration according to the position where the user touches on the panel has been proposed in the past. However, for the touch panel of a stationary machine, in spite of the effort to vibrate the panel uniformly, the vibration given to the finger which has touched it may be ununiform depending on the touched position as mentioned above, so it is difficult to control the vibration adequately.

The present invention has an object to provide an input device and image forming device which can present the user a response by vibration uniformly regardless of the position where the user touches on an operation panel.

To achieve at least one of the abovementioned objects, according to an aspect of the present invention, an input device reflecting one aspect of the present invention comprises: an operation panel unit which receives an operation input by a user; a vibrating element which is mounted on the operation panel unit and vibrates the operation panel unit in at least one direction; a vibration absorbing member which connects the operation panel unit with a device main body and absorbs vibration of the operation panel unit; and a vibration controller which enables the vibrating element to give a vibration according to the condition in which the operation input is received on the operation panel unit.

The vibration controller corrects the amount of vibration in driving the vibrating element by the amount of correction set according to the position where the vibrating element is mounted on the operation panel unit.

According to another aspect of the present invention, an image forming device reflecting one aspect of the present invention comprises: an image forming section which performs an image forming process on a printing medium; an operation panel unit which receives an operation input related to the image forming process by a user; a vibrating element which is mounted on the operation panel unit and vibrates the operation panel unit in at least one direction; a vibration absorbing member which connects the operation panel unit with a device main body and absorbs vibration of the operation panel unit; and a vibration controller which enables the vibrating element to give a vibration according to the condition in which the operation input is received on the operation panel unit.

The vibration controller corrects the amount of vibration in driving the vibrating element by the amount of correction set according to the position where the vibrating element is mounted on the operation panel unit.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a configuration diagram which shows an example of an image forming device according to an embodiment of the invention,

FIG. 2 is a block diagram which shows an example of the control configuration of the image forming device according to the embodiment of the invention,

FIG. 3 is a block diagram which shows an example of the configuration of an operation unit according to the embodiment of the invention,

FIG. 4 is a sectional view which shows an example of an operation panel unit according to the embodiment of the invention,

FIG. 5 is a flowchart which shows an example of control by a vibration controller according to the embodiment of the invention,

FIGS. 6A and 6B are top views of the operation panel unit according to the embodiment of the invention, in which FIG. 6A shows a case that the vibrating element is mounted on the gravity center axis and FIG. 6B shows a case that the vibrating element is mounted in a position shifted from the gravity center axis,

FIG. 7 is a diagram which shows an example of the relation between the touched position on the operation panel unit and the amount of correction according to the embodiment of the invention,

FIG. 8 is a diagram which shows an example of the areas of the operation surface of the operation panel unit and the amount of correction for each area according to the embodiment of the invention,

FIG. 9 is a flowchart which shows an example of the processing sequence of setting the amount of correction according to the embodiment of the invention,

FIG. 10 shows an example of a modification of the embodiment of the invention in which an extended operation unit is mounted and further correction is made, and

FIG. 11 is a flowchart which shows the control sequence according to the modification of the embodiment of the invention, in which the amount of correction is adjusted according to the detected value.

### DETAILED DESCRIPTION OF EMBODIMENTS

### [1. Example of the Configuration of the Device]

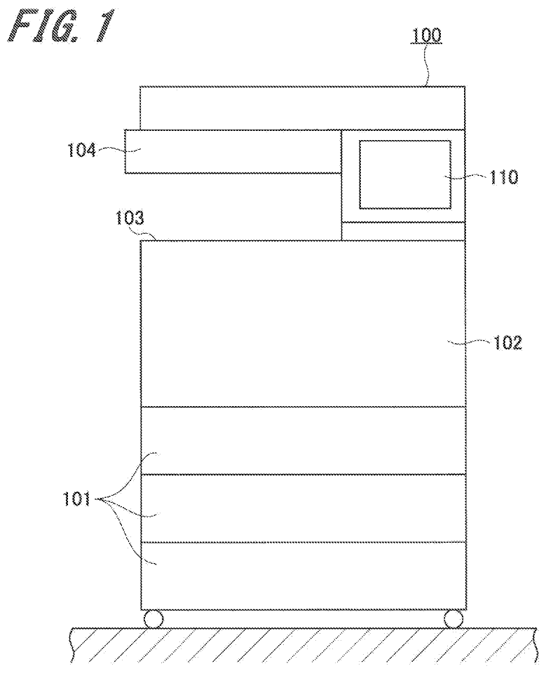

Hereinafter, one or more embodiments of the present invention will be described with reference to FIGS. 1 to 10. However, the scope of the invention is not limited to the disclosed embodiments.

FIG. 1 shows an example of an image forming device 100 according to an embodiment of the invention.

The image forming device 100 according to the embodiment is a digital multifunctional machine called MFP (MultiFunction Peripheral).

The image forming device 100 includes a paper cassette 101, an image forming section 102, a paper delivery section 103, an original reader 104, and an operation panel unit 110.

The image forming section 102 performs the image forming process to form an image on the front or back side of a sheet transported from the paper cassette 101 according to the original read by the original reader 104 or the original image transmitted from outside.

The sheet on which the image forming section 102 has formed an image is delivered through the paper delivery section 103.

The operation panel unit 110 is an operation section in which various settings related to the image forming process are made and an instruction to start image formation is given. This operation panel unit 110 includes a liquid crystal display panel which displays various operation buttons and a touch panel which detects a touch on the panel surface. The liquid crystal display panel is a relatively large panel which measures, for example, 10 centimeters in length and 20 centimeters in width.

In addition, the operation panel unit 110 according to the present embodiment has the function to vibrate the panel itself as a response to operation. This vibration function will be described in detail later.

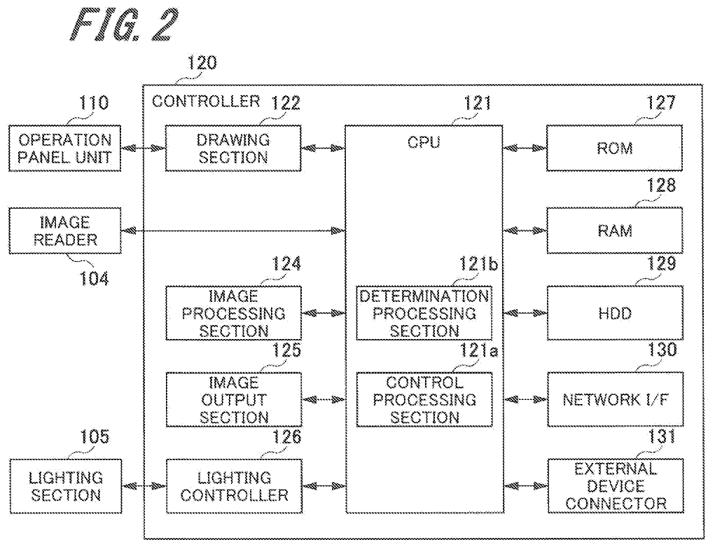

FIG. 2 shows an example of the configuration of the controller 120 of the image forming device 100. The image forming process by the image forming device 100 is performed under the control by the controller 120 built in the image forming device 100.

The controller 120 includes a central processing unit (hereinafter called the CPU) 121, a drawing section 122, an image processing section 124, an image output section 125, and a lighting controller 126. The controller 120 further includes a ROM 127, a RAM 128, a hard disk drive (hereinafter called the HDD) 129, a network interface 130, and an external device connector 131.

The CPU 121 reads the program or data required for control from the ROM 127, RAM 128 or HDD 129 connected to it and performs the control process to form an image. By executing the read program, a control processing section 121a which performs the control processing function is formed in the CPU 121. Also, by executing the read program, a determination processing section 121b which makes a determination about the conditions of various sections of the image forming device 100 is formed in the CPU 121.

The ROM 127 and RAM 128 are used to store data temporarily and the HDD 129 is mainly used to store image data (original data).

The network interface 130 connected to the CPU 121 receives original data and so on from outside. In addition, communications with a monitoring department in charge of monitoring the operation of the image forming device 100 are made through the network interface 130.

The CPU 121 performs the image forming process for the original read by the original reader 104 or the original received by the network interface 130. The CPU 121 is connected to the image processing section 124 and the image processing section 124 performs correction or processing of the image obtained from the original data. The image data processed by the image processing section 124 is sent from the image output section 125 so that an image is formed by the image forming section 102 (FIG. 1).

The CPU 121 is also connected to the drawing section 122 which draws the operation screen to be displayed on the operation panel unit 110, according to an instruction from the CPU 121. The operation panel unit 110 displays the operation screen drawn by the drawing section 122.

Furthermore, the CPU 121 is connected to the lighting controller 126 which controls lighting for the screen on the operation panel unit 110 according to an instruction from the CPU 121.

The controller 120 includes the external device connector 131 which enables connection to an external device such as a card reader or keyboard.

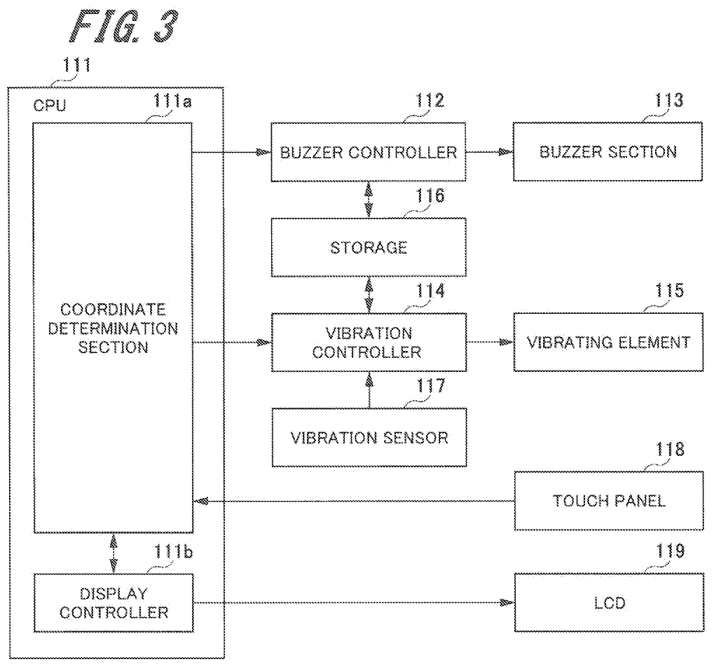

FIG. 3 shows the control configuration of the operation panel unit 110.

The operation panel unit 110 includes a CPU 111, a touch panel 118, and a liquid crystal display panel 119. The touch panel 118 detects a touch on the surface of the display screen of the liquid crystal display panel 119. The CPU 111 controls the detection of a touch on the touch panel 118 and the display on the liquid crystal display panel 119.

The CPU 111 includes a coordinate determination section 111a which determines the coordinates of the touched position on the touch panel 118 and a display controller 111b which controls the display on the liquid crystal display panel 119. The display controller 111b controls the display on the liquid crystal display panel 119 according to image data supplied from the drawing section 122 (FIG. 2) of the controller 120 of the image forming device 100.

The operation panel unit 110 further includes a buzzer section 113, a vibrating element 115, and a vibration sensor 117.

The buzzer section 113 outputs various sounds including a warning sound, under the control by a buzzer controller 112. The types of output sound and sound volume correction are set according to the data stored in a storage 116. The buzzer controller 112 controls the output of a warning sound or the like according to an instruction from the CPU 111.

The vibrating element 115 vibrates the touch panel 118 and the liquid crystal display panel 119 under the control by a vibration controller 114. Data such as the types of vibration and the amount of vibration correction for the touch panel 118 and the liquid crystal display panel 119 is stored in the storage 116. The vibration controller 114 reads the data stored in the storage 116 and controls the vibration condition according to an instruction from the CPU 111. The vibration sensor 117 detects the condition of the vibration given to the touch panel 118 and the liquid crystal display panel 119 by the vibrating element 115. As the vibration sensor 117, for example, a device which can detect the amount of vibration, such as an acceleration sensor, may be used.

The vibration sensor 117 is omissible. In the configuration shown in FIG. 3, the CPU 111 and the vibration controller 114 are separated. However, instead the CPU 111 may have the function as the vibration controller 114 so that the CPU 111 controls the vibrating element 115 directly.

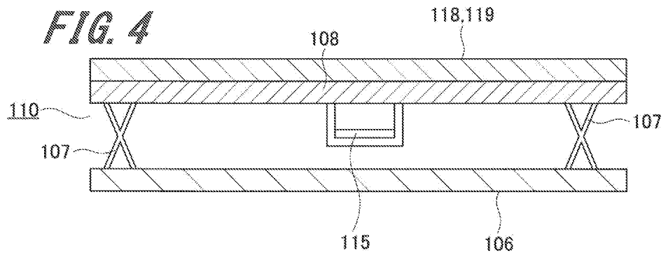

FIG. 4 is a sectional view of the operation panel unit 110 mounted on the image forming device 100. The touch panel 118 and liquid crystal display panel 119 of the operation panel unit 110 are located over an operation panel holding frame 108. The operation panel holding frame 108 is attached through a vibration absorbing member 107 to an operation panel mounting section 106 of the housing of the image forming device 100.

The vibration absorbing member 107 is made of rubber, spring or damper and placed in the four corners of the operation panel holding frame 108 or the like. This arrangement that the vibration absorbing members 107 are placed in the four corners is just an example; instead, for example, the vibration absorbing member 107 may be a rubber sheet which lies on the entire back side of the operation panel holding frame 108.

The vibrating element 115 is mounted on the back side of the operation panel holding frame 108. When a drive signal is applied, the vibrating element 115 vibrates the operation panel holding frame 108, touch panel 118, and liquid crystal display panel 119 in at least one direction. As the vibrating element 115, for example, a vibration motor with a weight attached eccentrically to the rotation shaft of the motor may be used.

Since the operation panel holding frame 108 is attached to the operation panel mounting section 106 through the vibration absorbing members 107, vibration is not transmitted to the main body side of the image forming device 100 other than the operation panel unit 110 and the operation panel unit 110 is vibrated efficiently while isolated from the main body side.

### [2. Processing Sequence of Vibrating the Touch Panel]

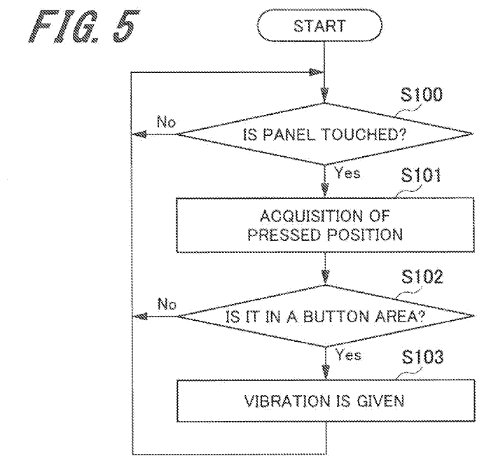

FIG. 5 is a flowchart which shows an example of the processing sequence in which the CPU 111 of the operation panel unit 110 vibrates the vibrating element 115.

First, the CPU 111 detects whether the touch panel 118 has been pressed (touched) or not (Step S100). Here, for example, the CPU 111 detects an interrupt signal from the touch panel 118 and determines whether the touch panel 118 has been pressed or not.

If the panel 118 has not been touched (No at Step S100), nothing is performed for vibration and this determination step is repeated until it is detected at Step S100 that the panel 118 has been touched.

If it is detected at Step S100 that the panel 118 has been touched (Yes at Step S100), the CPU 111 acquires information on the position on the touch panel 118 which has been pressed (Step S101). Furthermore, the CPU 111 determines whether the pressed position (touched position) acquired at Step S101 is in one of the button areas displayed on the liquid crystal display panel 119 (Step S102). If the pressed position is not in any button area (No at Step S102), the CPU 111 returns to Step S100 for determination and then, if the panel 118 is newly pressed, the same process as above is repeated.

On the other hand, if it is detected at Step S102 that the pressed position is in one of the button areas (Yes at Step S102), the CPU 111 instructs the vibration controller 114 to perform the vibration process (Step S103) and returns to Step S100 for determination. Then, if the panel 118 is newly pressed, the same process is repeated.

As the vibration controller 114 receives an instruction to perform the vibration process at Step S103, the vibration controller 114 vibrates the vibrating element 115 for a short time. For example, the vibration controller 114 vibrates the vibrating element 115 for a short time from 20 ms to 100 ms or so.

When the touch panel 118, just above the button displayed on the liquid crystal display panel 119, is pressed, this short-time vibration is given by the vibrating element 115 as a response to the press.

The touch panel 118 may be pressed with a finger of the user as the operator or with a touch pen prepared in advance.

### [3. Explanation of the Vibration Condition Depending on the Position of the Vibrating Element]

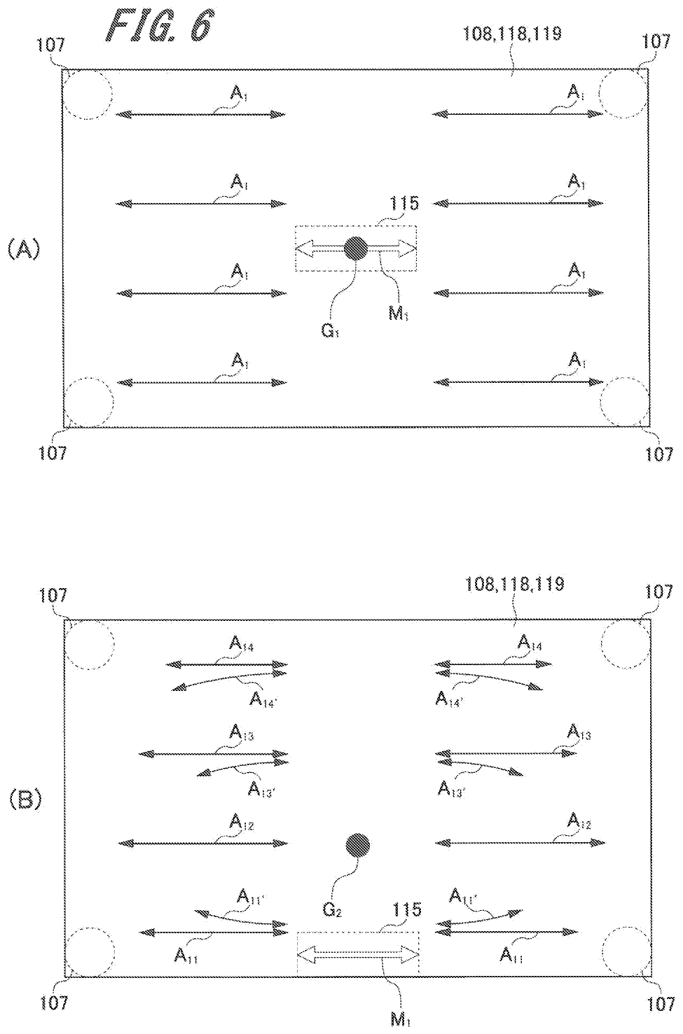

FIGS. 6A and 6B show how the touch panel 118 and liquid crystal display panel 119 mounted on the operation panel holding frame 108 when the vibrating element 115 is mounted on the operation panel holding frame 108 vibrate depending on the mounting position of the vibrating element 115.

FIG. 6A shows the vibration condition when the vibrating element 115 is mounted almost in the center of the operation panel holding frame 108. FIG. 6B shows the vibration condition when the vibrating element 115 is mounted at the nearer side end (lower side in FIG. 6B) of the operation panel holding frame 108.

The vibrating members described below are the operation panel holding frame 108 and the touch panel 118 and liquid crystal display panel 119 which are mounted on the operation panel holding frame 108. In the explanation given below, the horizontal direction means the left-right direction of the touch panel 118 shown in FIGS. 6A and 6B and the vertical direction means the vertical (up-down) direction of the touch panel 118 shown in FIGS. 6A and 6B.

In the present embodiment, the vibrating element 115 is arranged so that more vibration is given in the horizontal direction (in the left-right direction in FIGS. 6A and 6B). Therefore, for example, as shown in FIG. 6A, when the vibrating element 115 is mounted almost in the center of the operation panel holding frame 108, vibration M₁ of the vibrating element 115 produces horizontal vibration A₁ almost uniformly in all parts of the vibrating members (frame 108 and panels 118 and 119). In the example shown in FIG. 6A, position G₁ of the center of gravity of the vibrating members (frame 108 and panels 118 and 119) on which the vibrating element 115 is mounted is almost the center.

If the vibrating element 115 can be mounted almost in the center of the back side of the operation panel holding frame 108 as shown in FIG. 6A, all parts of the vibrating members vibrate almost uniformly and a satisfactory vibration condition is obtained.

However, in the actual image forming device 100, components are densely arranged inside the device for the sake of compactness of the device and it is often difficult to mount the vibrating element 115 almost in the center of the back side of the operation panel holding frame 108.

For this reason, as shown in FIG. 6B, in some cases the vibrating element 115 is mounted at the nearer side end (lower side in FIG. 6B) of the back side of the operation panel holding frame 108. In such cases, position G₂ of the center of gravity of the vibrating members (frame 108 and panels 118 and 119), on which the vibrating element 115 is mounted, deviates from the center toward the nearer side (lower side in FIG. 6B).

If the vibrating element 115 gives vibration M₁ in the horizontal direction as shown in FIG. 6B, strong vibration A₁₂ corresponding to vibration M₁ is produced in the same horizontal position as the position G₂ of the center of gravity. In contrast, as the distance from the position G₂ of the center of gravity in the vertical direction increases, the vibration gradually weakens. For example, at the nearer side end of the touch panel 118 in the vertical direction, the vibration is vibration A₁₁ which is weaker than vibration A₁₂. Also, at the farther side of the touch panel 118 in the vertical direction, as the distance from the position G₂ of the center of gravity increases, the vibration gradually weakens and becomes vibration A₁₃ or A₁₄.

In FIG. 6B, vibrations A₁₁ to A₁₄ given by the vibrating element 115 are expressed as horizontal movements (arrows). However, if movements in the positions deviated from the position G₂ of the center of gravity in the vertical direction are accurately expressed, they will be expressed by arched arrows A_{11′}, A_{12′}, A_{13′}, and A_{14′} as shown in FIG. 6B. In the explanation given below, the vibration given by the vibrating element 115 is assumed to be a horizontal movement. Although FIGS. 6A and 6B show examples that the position of the center of gravity is almost in the center in the horizontal direction, even if the position of the center of gravity deviates from the center in the horizontal direction, the amount of vibration of the vibrating members changes in the same way as shown in FIGS. 6A and 6B.

If the position of the vibrating element 115 deviates from the center of the vibrating members (frame 108 and panels 118 and 119) as shown in FIG. 6B, undesirably the vibration transmitted to the user who has touched the touch panel 118 would vary depending on the touched position, namely the vibration would be ununiform.

As a solution to this problem, in the image forming device 100 according to the present embodiment, the amount of vibration given by the vibrating element 115 is corrected according to the touched position so that the vibration is almost uniformly given regardless of the touched position.

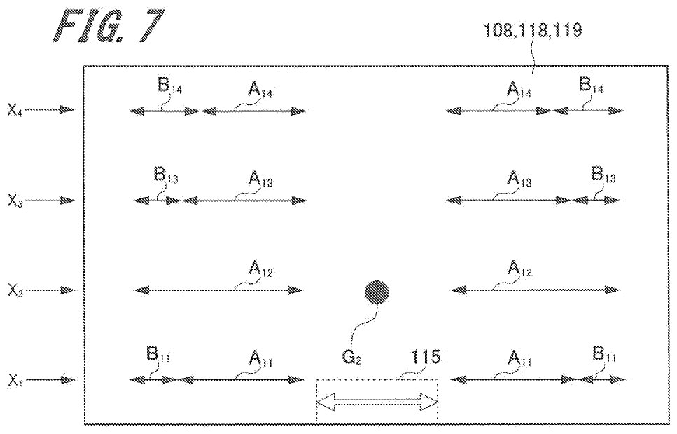

Specifically, as shown in FIG. 7, if an area of the touch panel 118 in the same horizontal direction X₂ as the position G₂ of the center of gravity of the vibrating members (frame 108 and panels 118 and 119) is touched, only the vibration A₁₂ is given by the vibrating element 115.

On the other hand, in the horizontal direction X₁ or X₃ away from the horizontal direction X₂ by a given distance in the vertical direction, the amount of correction corresponds to vibration B₁₁ or B₁₃ as the difference between vibration A₁₁ or A₁₃ given by the vibrating element 115 at that position and the strongest vibration A₁₂. Furthermore, in the horizontal direction X₄ further away from the horizontal direction X₂ in the vertical direction, the amount of correction corresponds to stronger vibration B₁₄ as the difference between vibration A₁₄ given by the vibrating element 115 at that position and the strongest vibration A₁₂.

The vibration controller 114 generates a drive signal for the vibrating element 115 to intensify the vibration by the amount of correction thus obtained according to the touched position and drives the vibrating element 115. The amount of correction may be determined, for example, by detecting the touched position of the touch panel 118 and calculating the required amount of correction for the detected position. However, in the present embodiment, the amount of correction is predetermined for each area of the panel so that the amount of correction is determined according to the area which covers the touched position.

### [4. Example of Correction of Vibration]

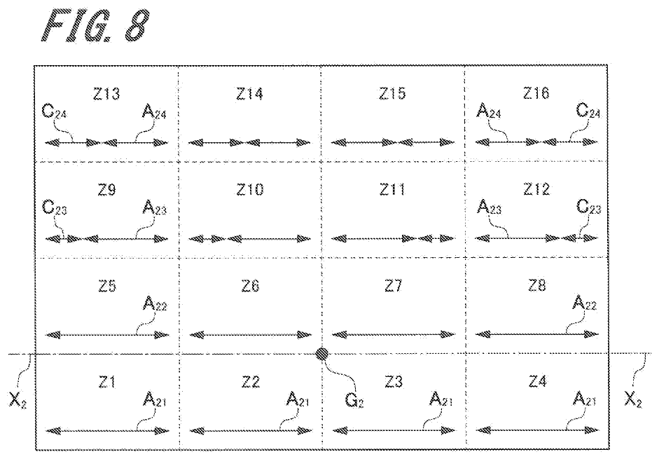

FIG. 8 shows an example that the surface of the touch panel 118 is divided into a plurality of areas. In this example, the surface is divided into 4 columns and 4 rows, namely Z1 to Z16. In the example shown in FIG. 8, the position G₂ of the center of gravity of the vibrating members including the touch panel 118 is on the boundary of the four areas Z2, Z3, Z6, and Z7. When the position of the center of gravity of the vibrating members is the position G₂ of the center of gravity shown in FIG. 8, the vibration is strongest at any position on the line of the horizontal direction X₂ including the position G₂ of the center of gravity.

Therefore, only vibrations A₂₁ and A₂₂ are given by the vibrating element 115 in the eight areas Z1 to Z8 which are in contact with the line of the horizontal direction X₂. In other words, the vibration is not corrected in the eight areas Z1 to Z8.

On the other hand, in the four areas Z9 to Z12, which are one area away from the line of the horizontal direction X₂ in the vertical direction, the vibration given by the vibrating element 115, expressed as A₂₃, is slightly weaker than the vibrations A₂₁ or A₂₂. Therefore, for the four areas Z9 to Z12, the difference between vibration A₂₁ and vibration A₂₃ (or the difference between vibration A₂₂ and vibration A₂₃) is set as the amount of vibration correction C₂₃.

Also, in the four areas Z13 to Z16, which are two areas away from the line of the horizontal direction X₂ in the vertical direction, the vibration given by the vibrating element 115, expressed as A₂₄, is weaker than the vibration A₂₃. Therefore, for the four areas Z13 to Z16, the difference between vibration A₂₁ and vibration A₂₄ (or the difference between vibration A₂₂ and vibration A₂₄) is set as the amount of vibration correction C₂₄.

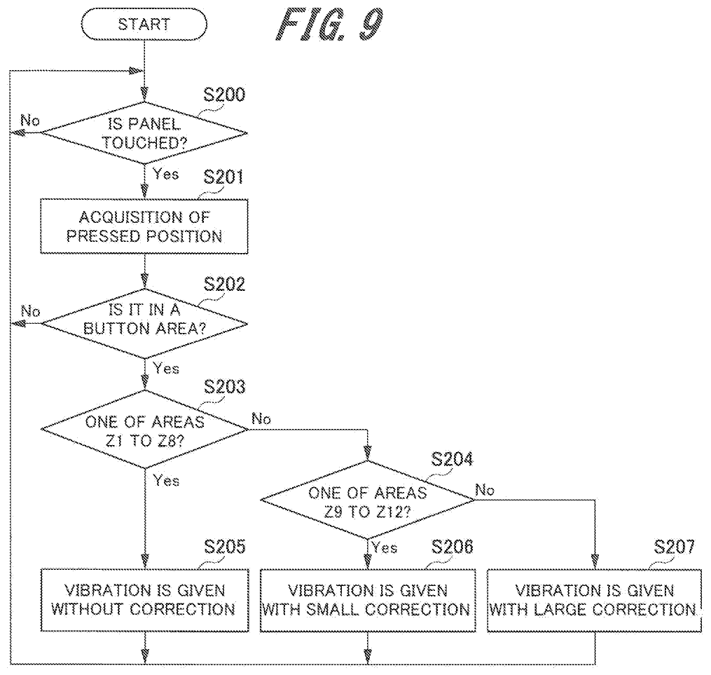

FIG. 9 is a flowchart which shows the sequence of setting an amount of correction when each area is touched. This correction sequence is controlled, for example, by the CPU 111 (FIG. 3).

First, the CPU 111 detects whether the touch panel 118 has been pressed (touched) or not (Step S200). For example, when the CPU 111 detects an interrupt signal from the touch panel 118, it determines that the panel has been pressed.

If the panel has not been touched (No at Step S200), nothing is performed to give a vibration and this determination step is repeated until it is detected at Step S200 that the touch panel 118 has been touched.

If it is detected at Step S200 that the touch panel 118 has been touched (Yes at Step S200), the CPU 111 acquires information on the pressed position on the touch panel 118 (Step S201). Furthermore, the CPU 111 determines whether the pressed position (touched position) is in one of the button areas displayed by the liquid crystal display panel 119 or not (Step S202). If the pressed position is not in any button area (No at Step S202), the CPU 111 returns to Step S200 for determination and then, if the panel 118 is newly pressed, the same steps as above are repeated.

The steps described so far are the same control steps as in the flowchart in FIG. 5. In this example, furthermore, Step S203 and subsequent steps are taken. Specifically, if it is determined at Step S202 that the pressed position is in one of the button areas (Yes at Step S202), the CPU 111 determines whether the touched position is in one of the areas Z1 to Z8 or not (Step S203).

If the touched position is in one of the areas Z1 to Z8 (Yes at Step S203), the CPU 111 instructs the vibration controller 114 to perform the vibration process without a correction (Step S205). After the vibration process is performed, the CPU 111 returns to Step S200 for determination and then, if the panel 118 is newly pressed, the same steps as above are repeated.

On the other hand, if the touched position is not in any of the areas Z1 to Z8 (No at Step S203), the CPU 111 determines whether the touched position is in one of the areas Z9 to Z12 or not (Step S204).

If the touched position is in one of the areas Z9 to Z12 (Yes at Step S204), the CPU 111 instructs the vibration controller 114 to perform the vibration process with a smaller amount of correction (amount of correction C₂₃ shown in FIG. 8) (Step S206). After the vibration process is performed, the CPU 111 returns to Step S200 for determination and then, if the panel 118 is newly pressed, the same steps as above are repeated.

If it is determined at Step S204 that the touched position is not in any of the areas Z9 to Z12 (No at Step S204), the CPU 111 determines that the touched position is in one of the areas Z13 to Z16. In this case, the CPU 111 instructs the vibration controller 114 to perform the vibration process with a larger amount of correction (amount of correction C₂₄ shown in FIG. 8) (Step S207). After the vibration process is performed, the CPU 111 returns to Step S200 for determination.

As explained above, in the image forming device according to the present embodiment, even if the vibrating element 115 cannot be mounted in the center of the touch panel 118, the vibration condition of the operation panel unit 110 can be corrected so that the vibration is almost uniform in all the areas of the touch panel 118. Therefore, the user who has operated the touch panel 118 can always feel a vibration with an adequate intensity regardless of which part of the touch panel 118 has been touched.

### [5. Example of Further Correction Necessary for Installation of an Extended Operation Device]

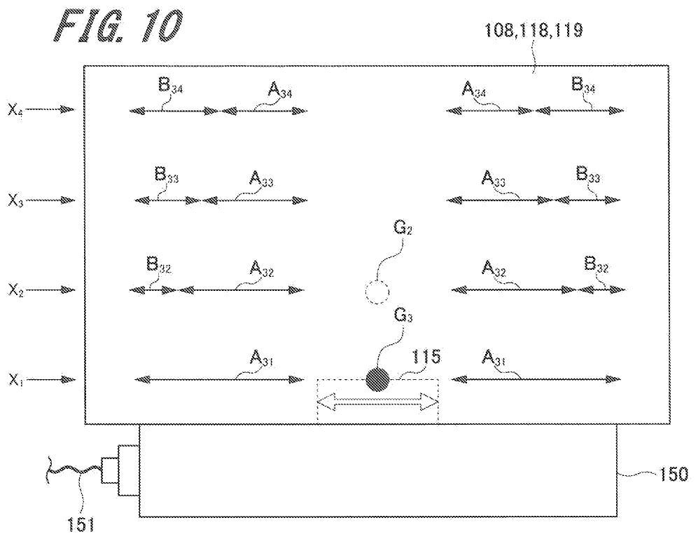

An external device (optional device) can be mounted on the operation panel unit 110. For example, as shown in FIG. 10, an external device 150 may be later installed on the touch panel 118 of the operation panel unit 110. The external device 150 is, for example, a keyboard or card reader. The external device 150 is connected to the CPU 111 of the image forming device 100, for example, by a cable 151.

If the external device 150 is installed as shown in FIG. 10, the position G₃ of the center of gravity of the vibrating members is shifted outward from the position G₂ of the center of gravity before installation of the device 150.

In this case, the amount of correction must be changed from the amount of correction shown in FIGS. 7 and 8 according to the change in the position of the center of gravity.

Specifically, if the touched position is along the line of the horizontal direction X₁ corresponding to the position G₃ of the center of gravity, only vibration A₃₁ is given by the vibrating element 115.

If the touched position is along the line of the horizontal direction X₂ shifted from the line of the horizontal direction X₁ in the vertical direction, the amount of correction B₃₂ which compensates for lack of vibration is added to the vibration A₃₂ given by the vibrating element 115.

Similarly, if the touched position is along the line of the horizontal direction X₃ or X₄ further shifted in the vertical direction, the amount of correction B₃₃ or B₃₄ which compensates for lack of vibration is added to the vibration A₃₃ or A₃₄ given by the vibrating element 115. The amount of correction B₃₂, B₃₃ or B₃₄ is larger as the distance from the position G₃ of the center of gravity in the vertical direction increases.

As explained above, even if the external device (optional device) 150 is installed on the operation panel unit 110, the vibration given to the operation panel unit 110 by the vibrating element 115 can be uniformized by correction.

### [6. Example of Compensation for Temporal Change in Vibration]

In the configuration described earlier in reference to FIG. 3, the operation panel unit 110 includes the vibration sensor 117 which detects the vibration given by the vibrating element 115. If it is detected that the amount of vibration changes over time from the amount of vibration detected by the vibration sensor 117, correction may be made to compensate for the amount of change.

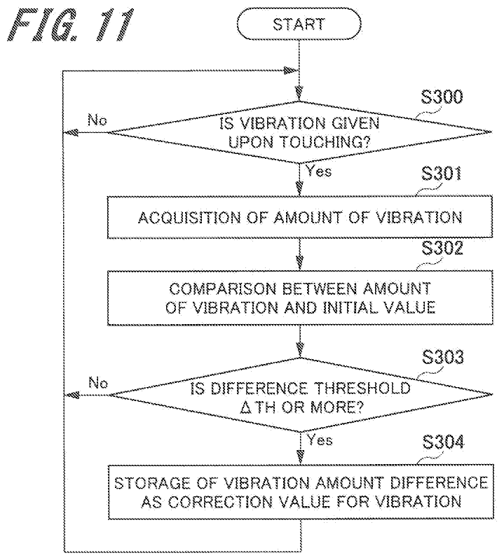

FIG. 11 is a flowchart which shows the sequence of compensating for the change in the amount of vibration.

First, the CPU 111 determines whether the vibrating element 115 has given a vibration upon touching the panel or not (Step S300). If a vibration has not been given (No at Step S300), the CPU 111 returns to Step 300 for determination and waits for a vibration.

If the vibrating element 115 has given a vibration upon touching the panel, the CPU 111 acquires the amount of vibration from the vibration sensor 117 (Step S301). Then, the CPU 111 compares the acquired amount of vibration with the initial value of the amount of vibration stored in advance (Step S302) and determines whether the difference between the acquired amount of vibration and the initial value is a preset threshold Δ TH or more (Step S303).

If the difference is not the threshold Δ TH or more (No at Step S303), the CPU 111 returns to Step S300 for determination and waits for a vibration.

If the difference is the threshold Δ TH or more (Yes at Step S303), the CPU 111 stores the value of the detected difference as a vibration correction value in the storage 116 (FIG. 3) and returns to Step 300 for determination (Step S304). When the correction value is stored in the storage 116, the CPU 111 (or the vibration controller 114) adds the stored correction value to drive signals to the vibrating element 115 for the next and subsequent vibrations.

Accordingly, when the vibration condition of the operation panel unit 110 has changed over time with the use of the image forming device 100, the change is automatically compensated for.

### [7. Other Modifications]

In the explanation of the above embodiment, the vibrating element 115 is assumed to give a vibration mainly in the horizontal direction of the operation panel unit 110. However, even when a vibration is given in a different direction, the vibration condition may be uniformized by the same steps as above.

In the example shown in FIG. 8, the touch panel is divided into a plurality of areas and a vibration correction value is obtained for each area, in which the correction values constitute a relatively small number of steps, such as two steps. An alternative approach to this may be that when the touch panel is touched, the touched position is detected and the correction value required for the touched position is acquired so that the vibration is uniformized more precisely.

In the description of the above embodiments, it is assumed that the operation panel unit included in the image forming device as a stationary machine is vibrated. In other various types of stationary machines, the same configuration and control process as above may also be used to vibrate the operation panel as an input device.

Although the embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

100 . . . image forming device,
101 . . . paper cassette,
102 . . . image forming section,
103 . . . paper delivery section,
104 . . . original reader,
105 . . . lighting section,
106 . . . operation panel mounting section,
107 . . . vibration absorbing member,
108 . . . operation panel holding frame,
110 . . . operation panel unit,
111 . . . central processing unit (CPU),
114 . . . vibration controller,
115 . . . vibrating element,
117 . . . vibration sensor,
118 . . . touch panel,
119 . . . liquid crystal display panel,
120 . . . controller,
121 . . . central processing unit (CPU),
131 . . . external device connector,
132 . . . connection cable,
140 . . . position adjusting section,
141 . . . adjusting screw,
142 . . . gravity center adjusting section,
143 . . . adjusting screw,
150 . . . external device

What is claimed is:

1. An input device comprising:
an operation panel unit which receives an operation input by a user;
a vibrating element which is mounted on the operation panel unit and vibrates the operation panel unit in at least one direction;
a vibration absorbing member which connects the operation panel unit with a device main body and absorbs vibration of the operation panel unit; and
a vibration controller which enables the vibrating element to give a vibration according to a condition in which the operation input is received on the operation panel unit, wherein
the vibration controller corrects an amount of vibration in driving the vibrating element by an amount of correction set according to a position where the vibrating element is mounted on the operation panel unit.

2. The input device according to claim 1, wherein the amount of correction is set according to an amount of shift of a mounting position of the vibrating element from a gravity center axis of the operation panel unit, and an area in which the operation input by the user has been made on the operation panel unit.

3. The input device according to claim 1, wherein the vibration controller divides an operation area of the operation panel unit into a plurality of areas, sets a correction value to correct the amount of vibration in driving the vibrating element for each of the areas, and corrects the amount of vibration of the vibrating element by the correction value set for the area in which the operation input is received on the operation panel unit.

4. The input device according to claim 1, further comprising:
a vibration amount detector which detects an amount of vibration given by the vibrating element, wherein
when the amount of vibration detected by the vibration amount detector changes, the vibration controller corrects the amount of vibration in driving the vibrating element according to information on the detected amount of vibration.

5. An image forming device comprising:
an image forming section which performs an image forming process on a printing medium;
an operation panel unit which receives an operation input related to the image forming process by a user;
a vibrating element which is mounted on the operation panel unit and vibrates the operation panel unit in at least one direction;
a vibration absorbing member which connects the operation panel unit with a device main body and absorbs vibration of the operation panel unit; and
a vibration controller which enables the vibrating element to give a vibration according to a condition in which the operation input is received on the operation panel unit, wherein
the vibration controller corrects an amount of vibration in driving the vibrating element by an amount of correction set according to a position where the vibrating element is mounted on the operation panel unit.
